(19) United States
(12) Patent Application Publication
(10) Pub. No.: US 2022/0219810 A1
(43) Pub. Date: Jul. 14, 2022

(54) SYSTEMS AND METHODS FOR PROTECTING FLIGHT CONTROL SYSTEMS

(71) Applicant: Bell Textron Inc., Fort Worth, TX (US)

(72) Inventors: Clifton L. HARRELL, Arlington, TX (US); Charles Eric COVINGTON, Colleyville, TX (US); David A. ADJEI, Mansfield, TX (US); Kevin Matthew TRENDEL, Hurst, TX (US); Michael David TRANTHAM, Arlington, TX (US); Randall JOHNSON, Grapevine, TX (US)

(73) Assignee: Bell Textron Inc., Fort Worth, TX (US)

(21) Appl. No.: 17/145,920

(22) Filed: Jan. 11, 2021

(51) Int. Cl. B64C 19/02; G05D 1/10

(52) U.S. Cl. CPC B64C 19/02; G05D 1/101

(57) ABSTRACT

In an embodiment, an aircraft includes a pilot input device, a position sensor coupled to the pilot input device, a flight condition sensor and a flight control computer (FCC). The FCC includes a first microprocessor and a second microprocessor. The first microprocessor is configured to receive input data from the position sensor and the condition sensor and determine therefrom a first output. The second microprocessor is configured to receive input data from the position sensor and the condition sensor and determine therefrom a second output. The FCC is configured to compare the first output and the second output to yield resultant data. Responsive to a determination that the first output and the second output do not match, the FCC is configured to execute first remediation logic if the resultant data satisfies first error criteria and to execute second remediation logic if the resultant data satisfies second error criteria.

### BACKGROUND

### Technical Field

The present disclosure relates generally to aircraft control and more particularly, but not by way of limitation, to systems and methods for protecting flight control systems.

History of Related Art

Modern flight control systems include one or more flight control computers that can be intimately involved in mission-critical flight control and stability functions. A rotorcraft, for example, may include one or more rotor systems including one or more main rotor systems. A main rotor system generates aerodynamic lift to support the weight of the rotorcraft in flight and thrust to move the rotorcraft in forward flight. Another example of a rotorcraft rotor system is a tail rotor system. A tail rotor system may generate thrust in the same direction as the main rotor system's rotation to counter the torque effect created by the main rotor system. For smooth and efficient flight in a rotorcraft, a pilot balances the engine power, main rotor collective thrust, main rotor cyclic thrust and the tail rotor thrust, and a flight control system may assist the pilot in stabilizing the rotorcraft and reducing pilot workload. Reliability is an important parameter for the flight control system.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, in an embodiment, an aircraft includes a pilot input device, a position sensor coupled to the pilot input device, a flight condition sensor and a flight control computer. The flight control computer includes a first microprocessor and a second microprocessor. The first microprocessor is configured to receive input data from the position sensor and the flight condition sensor and determine therefrom a first output. The second microprocessor is configured to receive input data from the position sensor and the flight condition sensor and determine therefrom a second output. The flight control computer is configured to compare the first output from the first microprocessor and the second output from the second microprocessor, the comparison yielding resultant data. Responsive to a determination that the first output and the second output do not match, the flight control computer is configured to execute first remediation logic if the resultant data satisfies first error criteria and to execute second remediation logic if the resultant data satisfies second error criteria. Other embodiments of this aspect include corresponding computer systems, apparatus, and computer programs recorded on one or more computer storage devices, each configured to perform the actions of the methods.

In another general aspect, in an embodiment, a method is performed by a flight control computer. The method includes comparing a first output from a first microprocessor and a second output from a second microprocessor, the comparing yielding resultant data. The method also includes, responsive to a determination that the first output and the second output do not match, executing first remediation logic if the resultant data satisfies first error criteria and executing second remediation logic if the resultant data satisfies second error criteria. Other embodiments of this aspect include corresponding computer systems, apparatus, and computer programs recorded on one or more computer storage devices, each configured to perform the actions of the methods.

In another general aspect, in an embodiment, a flight control computer for an aircraft includes a first microprocessor and a second microprocessor. The first microprocessor is configured to receive input data including a position and a flight condition and to determine therefrom a first output. The second microprocessor is configured to receive input data including a position and a flight condition and determine therefrom a second output. The flight control computer is configured to compare the first output from the first microprocessor and the second output from the second microprocessor, the comparison yielding resultant data. Responsive to a determination that the first output and the second output do not match, the flight control computer is configured to execute first remediation logic if the resultant data satisfies first error criteria and to execute second remediation logic if the resultant data satisfies second error criteria. Other embodiments of this aspect include corresponding computer systems, apparatus, and computer programs recorded on one or more computer storage devices, each configured to perform the actions of the methods.

### BRIEF DESCRIPTION OF THE DRAWINGS

A more complete understanding of the method and apparatus of the present disclosure may be obtained by reference to the following Detailed Description when taken in conjunction with the accompanying Drawings wherein:

FIG. 1 illustrates a rotorcraft;

FIG. 2 illustrates a fly-by-wire flight control system for a rotorcraft;

FIG. 3 schematically illustrates a manner in which a flight control system may implement fly-by-wire functions as a series of inter-related feedback loops running control laws;

FIG. 4 illustrates a flight control system;

FIG. 5 illustrates certain aspects of an illustrative flight control computer;

and

FIG. 6 illustrates an example of a process for performing multiple levels of remediation in a flight control system.

### DETAILED DESCRIPTION

Illustrative embodiments of the system and method of the present disclosure are described below. In the interest of clarity, all features of an actual implementation may not be described in this specification. It will of course be appreciated that in the development of any such actual embodiment, numerous implementation-specific decisions may be made to achieve the developer's specific goals, such as compliance with system-related and business-related constraints, which will vary from one implementation to another. Moreover, it should be appreciated that such a development effort might be complex and time-consuming but would nevertheless be a routine undertaking for those of ordinary skill in the art having the benefit of this disclosure.

Reference may be made herein to the spatial relationships between various components and to the spatial orientation of various aspects of components as the devices are depicted in the attached drawings. However, as will be recognized by those skilled in the art after a complete reading of the present disclosure, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

The increasing use of rotorcraft, in particular, for commercial, military, and industrial applications, has led to the development of larger more complex rotorcraft. However, as rotorcraft become larger and more complex, the differences between flying rotorcraft and fixed wing aircraft has become more pronounced. Since rotorcraft use one or more main rotors to simultaneously provide lift, control attitude, control altitude, and provide lateral or positional movement, different flight parameters and controls are tightly coupled to each other, as the aerodynamic characteristics of the main rotors affect each control and movement axis. For example, the flight characteristics of a rotorcraft at cruising speed or high speed may be significantly different than the flight characteristics at hover or at relatively low speeds. Additionally, different flight control inputs for different axes on the main rotor, such as cyclic inputs or collective inputs, affect other flight controls or flight characteristics of the rotorcraft. For example, pitching the nose of a rotorcraft forward or down will generally cause the rotorcraft to lose altitude. In such a situation, the collective may be increased to maintain level flight, but the increase in collective requires increased power at the main rotor which, in turn, requires additional anti-torque force from the tail rotor. This is in contrast to fixed wing systems where the control inputs are less closely tied to each other and flight characteristics in different speed regimes are more closely related to each other.

Recently, fly-by-wire (FBW) systems have been introduced in rotorcraft to assist pilots in stably flying the rotorcraft and to reduce workload on the pilots. The FBW system may provide different control characteristics or responses for cyclic, pedal or collective control input in the different flight regimes, and may provide stability assistance or enhancement by decoupling physical flight characteristics so that a pilot is relieved from needing to compensate for some flight commands issued to the rotorcraft. FBW systems may be implemented in one or more flight control computers (FCCs), which FCCs provide corrections to flight controls that assist in operating the rotorcraft more efficiently or that put the rotorcraft into a stable flight mode while still allowing the pilot to override the FBW control inputs. The FBW systems in a rotorcraft may, for example, automatically adjust power output by the engine to match a collective control input, apply collective or power correction during a cyclic control input, provide automation of one or more flight control procedures, provide for default or suggested control positioning, or the like.

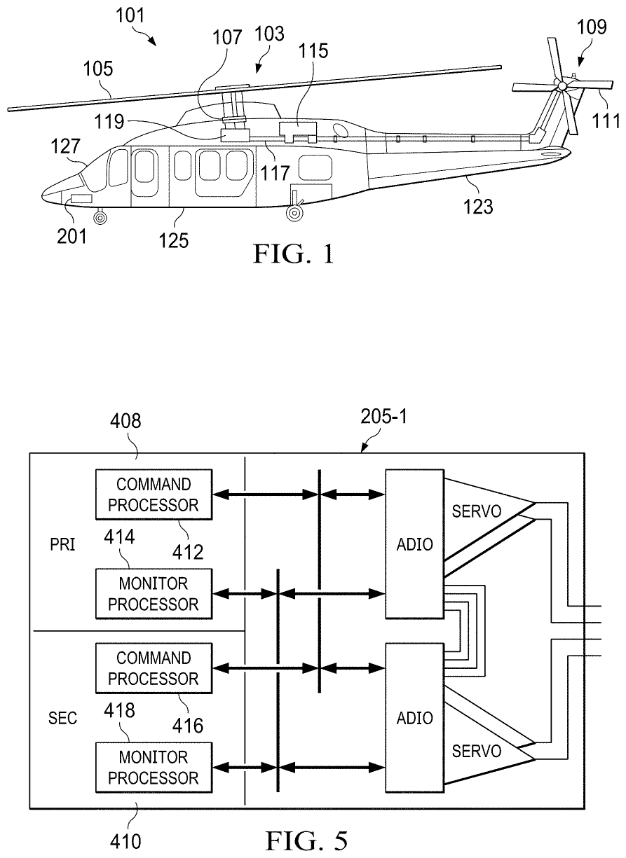

FIG. 1 illustrates a rotorcraft 101 according to some embodiments. The rotorcraft 101 has a main rotor system 103, which includes a plurality of main rotor blades 105. The pitch of each main rotor blade 105 may be controlled by a swashplate 107 in order to selectively control the attitude, altitude and movement of the rotorcraft 101. The swashplate 107 may be used to collectively and/or cyclically change the pitch of the main rotor blades 105. The rotorcraft 101 also has an anti-torque system, which may include a tail rotor 109, no-tail-rotor (NOTAR), or dual main rotor system. In rotorcraft with a tail rotor 109, the pitch of each tail rotor blade 111 is collectively changed in order to vary thrust of the anti-torque system, providing directional control of the rotorcraft 101. The pitch of the tail rotor blades 111 is changed by one or more tail rotor actuators. In some embodiments, the FBW system sends electrical signals to the tail rotor actuators or main rotor actuators to control flight of the rotorcraft.

Power is supplied to the main rotor system 103 and the anti-torque system by engines 115. There may be one or more engines 115, which may be controlled according to signals from the FBW system. The output of the engine 115 is provided to a driveshaft 117, which is mechanically and operatively coupled to the rotor system 103 and the anti-torque system through a main rotor transmission 119 and a tail rotor transmission 121, respectively.

The rotorcraft 101 further includes a fuselage 125 and tail section 123. The tail section 123 may have other flight control devices such as horizontal or vertical stabilizers, rudders, elevators, or other control or stabilizing surfaces that are used to control or stabilize flight of the rotorcraft 101. The fuselage 125 includes a cockpit 127, which includes displays, controls, and instruments. It should be appreciated that even though rotorcraft 101 is depicted as having certain illustrated features, the rotorcraft 101 may have a variety of implementation-specific configurations. For instance, in some embodiments, cockpit 127 is configured to accommodate a pilot or a pilot and co-pilot, as illustrated. It is also contemplated, however, that rotorcraft 101 may be operated remotely, in which case cockpit 127 could be configured as a fully functioning cockpit to accommodate a pilot (and possibly a co-pilot as well) to provide for greater flexibility of use, or could be configured with a cockpit having limited functionality (e.g., a cockpit with accommodations for only one person who would function as the pilot operating perhaps with a remote co-pilot or who would function as a co-pilot or back-up pilot with the primary piloting functions being performed remotely). In yet other contemplated embodiments, rotorcraft 101 could be configured as an unmanned vehicle.

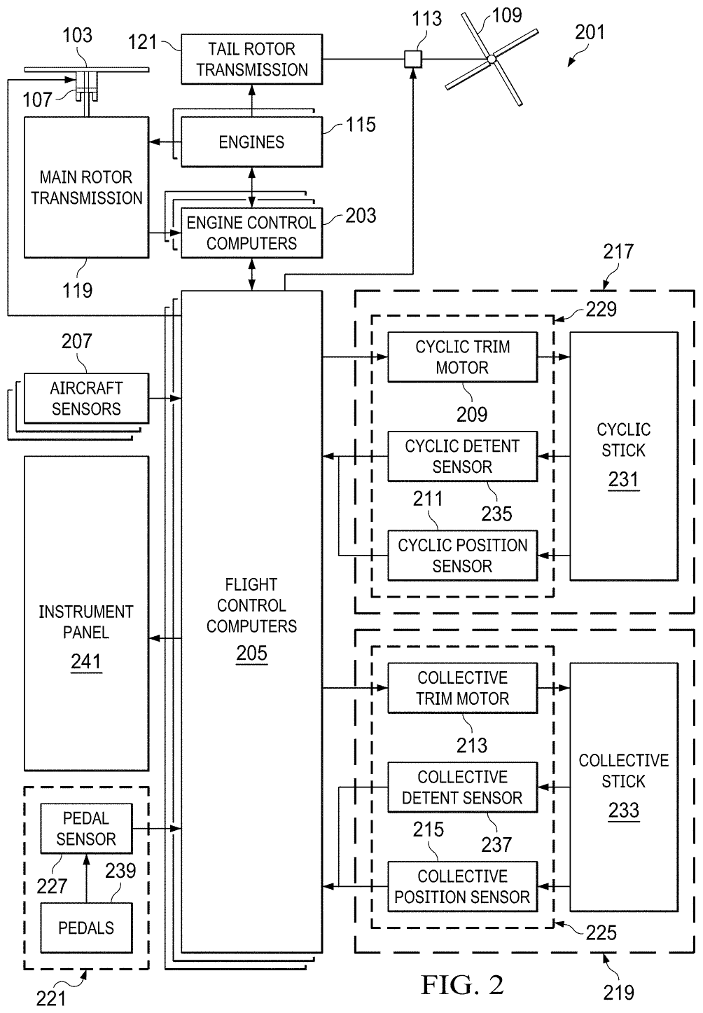

FIG. 2 illustrates a FBW flight control system 201 for a rotorcraft according to some embodiments. A pilot may manipulate one or more pilot flight controls in order to control flight of the rotorcraft. The pilot flight controls may include manual controls such as a cyclic stick 231 in a cyclic control assembly 217, a collective stick 233 in a collective control assembly 219, and pedals 239 in a pedal control assembly 221. Inputs provided by the pilot to the pilot flight controls may be transmitted mechanically and/or electronically (e.g., via the FBW flight control system) to flight control devices by the flight control system 201. Flight control devices may represent devices operable to change the flight characteristics of the rotorcraft. Flight control devices on the rotorcraft may include mechanical and/or electrical systems operable to change the positions or angle of attack of the main rotor blades 105 and the tail rotor blades 111 or to change the power output of the engines 115, as examples. Flight control devices include systems such as the swashplate 107, tail rotor actuator 113, and systems operable to control the engines 115. The flight control system 201 may adjust the flight control devices independently of the flight crew in order to stabilize the rotorcraft, reduce workload of the flight crew, and the like. The flight control system 201 includes engine control computers (ECCUs) 203, flight control computers (FCCs) 205, and aircraft sensors 207, which collectively adjust the flight control devices.

The flight control system 201 has one or more FCCs 205. In some embodiments, multiple FCCs 205 are provided for redundancy. One or more modules within the FCCs 205 may be partially or wholly embodied as software and/or hardware for performing any functionality described herein. In embodiments where the flight control system 201 is a FBW flight control system, the FCCs 205 may analyze pilot inputs and dispatch corresponding commands to the ECCUs 203, the tail rotor actuator 113, and/or actuators for the swashplate 107. Further, the FCCs 205 are configured and receive input commands from the pilot controls through sensors associated with each of the pilot flight controls. The input commands are received by measuring the positions of the pilot controls. The FCCs 205 also control tactile cueing commands to the pilot controls or display information in instruments on, for example, an instrument panel 241.

The ECCUs 203 control the engines 115. For example, the ECCUs 203 may vary the output power of the engines 115 to control the rotational speed of the main rotor blades or the tail rotor blades. The ECCUs 203 may control the output power of the engines 115 according to commands from the FCCs 205, or may do so based on feedback such as measured RPM of the main rotor blades.

The aircraft sensors 207 are in communication with the FCCs 205. The aircraft sensors 207 may include sensors for measuring a variety of rotorcraft systems, flight parameters, environmental conditions and the like. For example, the aircraft sensors 207 may include sensors for measuring airspeed, altitude, attitude, position, orientation, temperature, vertical speed, and the like. Other sensors 207 could include sensors relying upon data or signals originating external to the rotorcraft, such as a global positioning system (GPS) sensor, a VHF Omnidirectional Range sensor, Instrument Landing System (ILS), and the like.

The cyclic control assembly 217 is connected to a cyclic trim assembly 229 having one or more cyclic position sensors 211, one or more cyclic detent sensors 235, and one or more cyclic actuators or cyclic trim motors 209. The cyclic position sensors 211 measure the position of the cyclic stick 231. In some embodiments, the cyclic stick 231 is a single control stick that moves along two axes and permits a pilot to control pitch, which is the vertical angle of the nose of the rotorcraft and roll, which is the side-to-side angle of the rotorcraft. In some embodiments, the cyclic control assembly 217 has separate cyclic position sensors 211 that measure roll and pitch separately. The cyclic position sensors 211 for detecting roll and pitch generate roll and pitch signals, respectively, (sometimes referred to as cyclic longitude and cyclic latitude signals, respectively) which are sent to the FCCs 205, which controls the swashplate 107, engines 115, tail rotor 109 or related flight control devices. The cyclic trim motors 209 are connected to the FCCs 205, and receive signals from the FCCs 205 to move the cyclic stick 231.

Similar to the cyclic control assembly 217, the collective control assembly 219 is connected to a collective trim assembly 225 having one or more collective position sensors 215, one or more collective detent sensors 237, and one or more collective actuators or collective trim motors 213. The collective position sensors 215 measure the position of a collective stick 233 in the collective control assembly 219. In some embodiments, the collective stick 233 is a single control stick that moves along a single axis or with a lever type action. A collective position sensor 215 detects the position of the collective stick 233 and sends a collective position signal to the FCCs 205, which may control engines 115, swashplate actuators, or related flight control devices according to the collective position signal to control the vertical movement of the rotorcraft. In some embodiments, the FCCs 205 may send a power command signal to the ECCUs 203 and a collective command signal to the main rotor or swashplate actuators so that the angle of attack of the main blades is raised or lowered collectively, and the engine power is set to provide the needed power to keep the main rotor RPM substantially constant. The collective trim motor 213 is connected to the FCCs 205, and receives signals from the FCCs 205 to move the collective stick 233.

The pedal control assembly 221 has one or more pedal sensors 227 that measure the position of pedals or other input elements in the pedal control assembly 221. In some embodiments, the pedal control assembly 221 is free of a trim motor or actuator, and may have a mechanical return element that centers the pedals when the pilot releases the pedals. In other embodiments, the pedal control assembly 221 has one or more trim motors that drive the pedal to a pedal position according to a signal from the FCCs 205. The pedal sensor 227 detects the position of the pedals 239 and sends a pedal position signal to the FCCs 205, which controls the tail rotor 109 to cause the rotorcraft to yaw or rotate around a vertical axis.

The cyclic and collective trim motors 209 and 213 may drive the cyclic stick 231 and collective stick 233, respectively, to particular positions, but this movement capability may also be used to provide tactile cueing to a pilot. The trim motors 209 and 213 may push the respective stick in a particular direction when the pilot is moving the stick to indicate a particular condition. Since the FBW system mechanically disconnects the stick from one or more flight control devices, a pilot may not feel a hard stop, vibration, or other tactile cue that would be inherent in a stick that is mechanically connected to a flight control assembly. In some embodiments, the FCCs 205 may cause the trim motors 209 and 213 to push against a pilot command so that the pilot feels a resistive force, or may command one or more friction devices to provide friction felt when the pilot moves the stick. Thus, the FCCs 205 control the feel of a stick by providing pressure and/or friction on the stick.

Additionally, the cyclic control assembly 217, collective control assembly 219 and/or pedal control assembly 221 may each have one or more detent sensors that determine whether the pilot is handling a particular control device. For example, the cyclic control assembly 217 may have a cyclic detent sensor 235 that determines that the pilot is holding the cyclic stick 231, while the collective control assembly 219 has a collective detent sensor 237 that determines whether the pilot is holding the collective stick 233. These detent sensors 235, 237 detect motion and/or position of the respective control stick that is caused by pilot input, as opposed to motion and/or position caused by commands from the FCCs 205, rotorcraft vibration, and the like, and provide feedback signals indicative of such to the FCCs 205. When the FCCs 205 detect that a pilot has control of, or is manipulating, a particular control, the FCCs 205 may determine that stick to be out-of-detent (00D). Likewise, the FCCs may determine that the stick is in-detent (ID) when the signals from the detent sensors indicate to the FCCs 205 that the pilot has released a particular stick. The FCCs 205 may provide different default control or automated commands to one or more flight systems based on the detent status of a particular stick or pilot control.

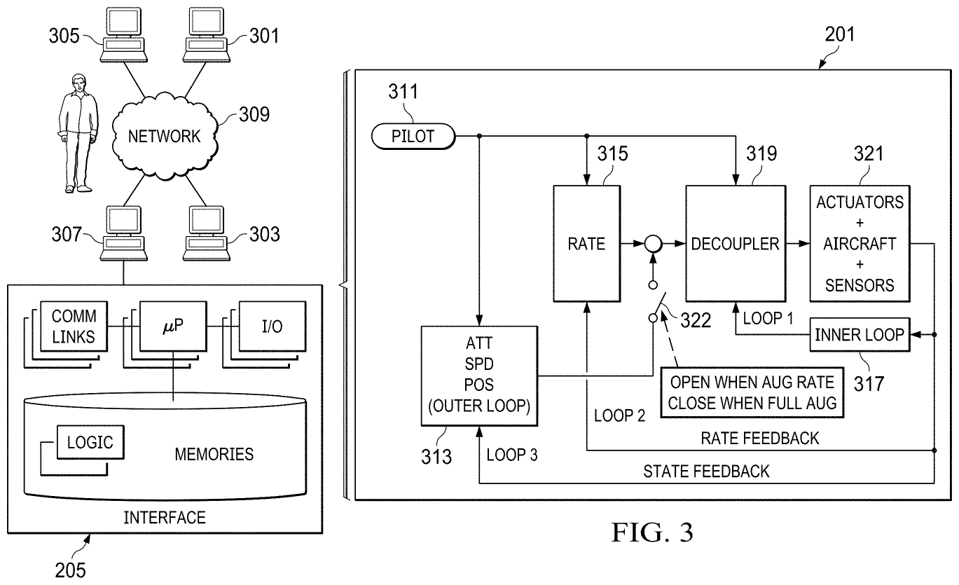

Moving now to the operational aspects of flight control system 201, FIG. 3 illustrates a manner in which flight control system 201 may implement FBW functions as a series of inter-related feedback loops running certain control laws. FIG. 3 representatively illustrates a three-loop flight control system 201 according to an embodiment. In some embodiments, elements of the three-loop flight control system 201 may be implemented at least partially by FCCs 205. As shown in FIG. 3, however, all, some, or none of the components (301, 303, 305, 307) of three-loop flight control system 201 could be located external or remote from the rotorcraft 100 and communicate to on-board devices through a network connection 309.

The three-loop flight control system 201 of FIG. 3 has a pilot input 311, an outer loop 313, a rate (middle) loop 315, an inner loop 317, a decoupler 319, and aircraft equipment 321 (corresponding, e.g., to flight control devices such as swashplate 107, tail rotor transmission 121, etc., to actuators (not shown) driving the flight control devices, to sensors such as aircraft sensors 207, position sensors 211, 215, detent sensors 235, 237, etc., and the like).

In the example of FIG. 3, a three-loop design separates the inner stabilization and rate feedback loops from outer guidance and tracking loops. The control law structure primarily assigns the overall stabilization task and related tasks of reducing pilot workload to inner loop 317. Next, middle loop 315 provides rate augmentation. Outer loop 313 focuses on guidance and tracking tasks. Since inner loop 317 and rate loop 315 provide most of the stabilization, less control effort is required at the outer loop level. As representatively illustrated in FIG. 3, a switch 322 may be provided to turn outer loop flight augmentation on (e.g., “FULL AUG”) and off (e.g., “AUG RATE”), as the tasks of outer loop 313 are not necessary for flight stabilization.

In some embodiments, the inner loop 317 and rate loop 315 include a set of gains and filters applied to roll/pitch/yaw 3-axis rate gyro and acceleration feedback sensors. Both the inner loop 317 and rate loop 315 may stay active, independent of various outer loop hold modes. Outer loop 313 may include cascaded layers of loops, including an attitude loop, a speed loop, a position loop, a vertical speed loop, an altitude loop, and a heading loop. Furthermore, the outer loop 313 may allow for automated or semi-automated operation of certain high-level tasks or flight patterns, thus further relieving the pilot workload and allowing the pilot to focus on other matters including observation of the surrounding terrain.

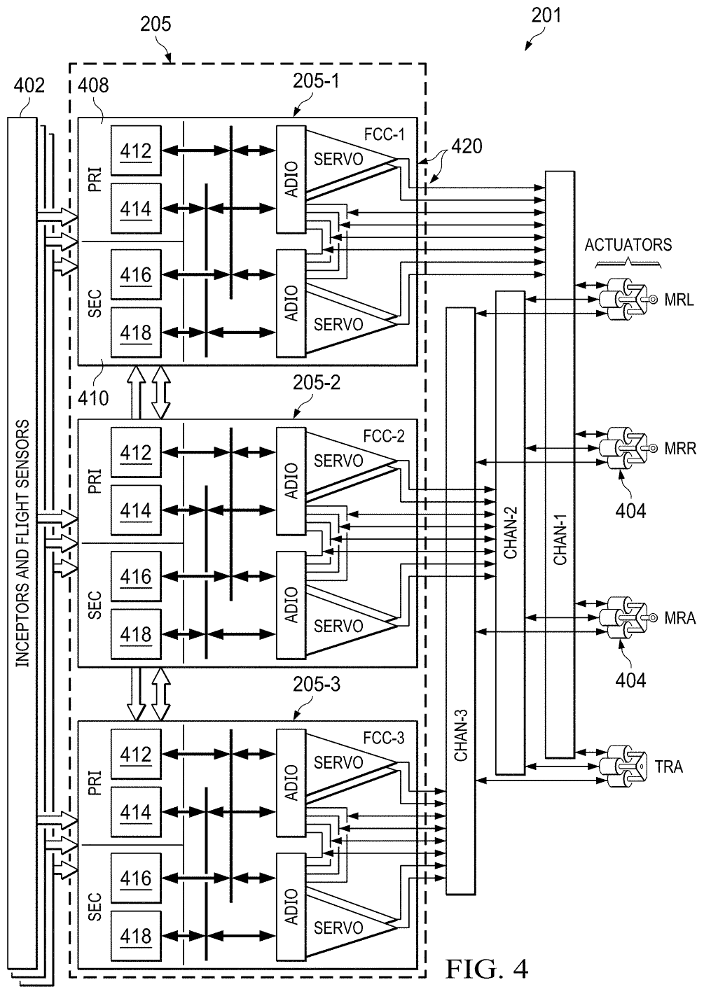

FIG. 4 illustrates flight control system 201 at a different level of abstraction. At its simplest, flight control system 201 can be considered to include a series of sensors 402 serving as input devices feeding FCCs 205, which in some embodiments can be thought of as a series of state machines running the control laws that control flight operations and which, in turn, drive actuators 404 to control various flight control device of rotorcraft 101. Sensors 402 can include a variety of different sensors. For example, sensors 402 can include sensors for sensing pilot commands such as (with reference to FIG. 2) cyclic position sensor 211, collective position sensor 215, pedal sensors 227 as well as sensors for detecting other pilot input including activation of a beep switch, activation of some other switch, touch on a touch sensitive contact surface, selection of a command menu item on a user interface, and the like. Sensors 402 can also include sensors 207 discussed above. While FIG. 4 schematically illustrates output from sensors 402 being fed directly to FCCs 205, one skilled in the art will recognize that in some embodiments, signal processing or logic circuitry may be interjacent sensors 402 and FCCs 205, e.g. to convert the output of sensors 402 from an analog format to a digital format or to otherwise translate the format of data output by sensors 402 into a data format expected by FCCs 205.

Actuators 404 may be hydraulic actuators, pneumatic actuators, mechanical actuators that include a driveshaft driven by a step motor, or the like. In the presently contemplated embodiments, actuators 404 include feedback elements, such as a position sensor or the like, which in turn are another category of sensors 402. Flight control devices 406 may include swashplate 107, for adjusting the pitch of main rotor blades 105, a rudder, and the like.

Because flight control system 201 is responsible for numerous “mission critical” functions to maintain safe and expected control of rotorcraft 101, it is generally important that flight control system 201 have a high degree of reliability. Some governmental agencies impose reliability standards for mission critical type functions and systems such as flight control system 201, and in particular the FCCs 205 upon which certain components of the flight control system are implemented in the embodiments described herein. In order to ensure such a high degree of reliability, several levels of redundancy and self-checking are built into the illustrative flight control system 201 and FCCs 205 described herein. As shown in FIG. 4, FCCs 205 may be implemented as several redundant FCCs, 205-1, 205-2 and 205-3. In the illustrated embodiments, each of the redundant FCCs is a mirror copy of the others and is nominally fully functioning at all times. Whereas three redundant FCCs are illustrated, as a matter of design choice two or more than three redundant FCCs could be used. Additionally, while 100% redundancy between the redundant FCCs is illustrated, in some embodiments, only a portion or portions of the FCC is replicated in a redundant portion or portions.

Operational tasks can be apportioned amongst the redundant FCCs in various ways. For example, in one embodiment, FCC 205-1 is the primary FCC and is responsible for all tasks, while FCCs 205-2 and 205-3 are merely back-up systems in the event that FCC 205-1 fails or is otherwise unable to perform operational tasks. In another embodiment, however, operational tasks are shared equally among each of the redundant FCCs 205-1, 205-2 and 205-3. In this way, the overall workload can be apportioned amongst the multiple computers, allowing each of the redundant computers to operate more efficiently and with little or no change of a single redundant FCC being overloaded in a scenario requiring inordinate tasks or processing.

Another level of redundancy is illustrated in FIG. 4, with each redundant FCC having a first processing lane 408, sometimes referred to as a primary processing lane, and a redundant processing lane 410, sometimes referred to as a secondary processing lane. In some embodiments, primary processing lane 408 and secondary processing lane 410 are mirror images of each other. In some embodiments, primary processing lane 408 and secondary processing lane 410 may differ in a material respect. For example, in order to increase the reliability of FCC 205, different processors may be chosen for processing lane 408. In this way, an error (whether of design, or manufacture, or programming, etc.) that negatively impacts the reliability and/or performance of processor 412 is less likely to also exist in a different processor 414.

In general, primary processing lane 408 and secondary processing lane 410 provide yet another level of redundancy. Reference is made to FIG. 5, which illustrates FCC 205-1 in greater detail. The following discussion applies equally to FCCs 205-2 and 205-3. As shown in FIG. 5, each processing lane 408, 410 has two separate processors operating in the lane. Processing lane 408 includes a first processor 412, sometimes referred to as a command processor, and a second processor 414, sometimes referred to as a monitor processor, for reasons that will be apparent in the following discussion. Likewise, processing lane 410 has a first or command processor 416 and a second or monitor processor 418.

The term processor can have different meanings in different contexts, including within the confines of this disclosure. Without limiting the generality of the term processor, in the specific context of the illustration of FIG. 5, processor refers to a microprocessor unit (typically but not mandatorily formed as a single-chip or multi-chip integrated circuit product) that, along with associated support logic, memory devices, etc., run preprogrammed instruction to perform desired operations of FCC 205. Each processor 412, 414, 416, 418 could be a general purpose microprocessor or microcontroller. In other embodiments, each processor 412, 414, 416, 418 could be a special purpose processor, such as a digital signal processor.

In some embodiments, redundant processing lane 410 could also include redundant processors 416, 418 that differ in a material aspect in similar fashion to processor 412 and process 414 as discussed above. In the illustrated embodiment, however, redundant processing lane 410 is designed with two processors 416, 418 that are “identical,” meaning for the purpose of this discussion that, in the absence of an error or defect, the same result will always be output from the first processor and the second microprocessor when the first processor and the second processor receive identical input data and run identical program steps on the identical input data. Although processors 416, 418 might be identical to one another, to avoid the duplication of defect concerns discussed above, in some embodiments, processors 416 and 418 may also differ in a material respect from one or both of processors 412 and 414.

One skilled in the art will recognize improved system reliability is provided by implementation of redundant processing lanes 408 and 410 that include redundant processors 412, 414 and 416, 418, respectively. For instance, in one contemplated embodiment, processing lane 408 is considered the primary processing lane and handles the computational functions of FCC 205. In the event that processing lane 408 fails, computation functions can be routed to secondary processing lane 410 without any loss of performance or functionality. Similarly, a switch-over can be implemented if processors 412 and 414, for instance, differ from one another by above a certain threshold, as discussed further below. FIG. 4 also illustrates redundant busses and I/O circuitry 420 by which control signals generated by the processing lanes can be communicated, e.g., to actuators 404.

Returning attention now to processing lane 408, even though processor 412 is designated as a primary processor and processor 414 is designated as a monitor processor, in the design of the illustrated system, both processor 412 and processor 414 are fully functioning at all times. In other words, processor 412 and processor 414 are on “parallel paths” in the flow of data and commands within FCCs 205. As stated previously, both processor 412 and processor 414 receive identical input data (e.g., from sensors 402) and run identical programs (e.g., the control laws by which FBW control signals are generated). Under these circumstances, one would expect identical results to be output from two processors running identical programs using identical input data, and under most circumstances, this is the case. Because processors 412 and 414 may differ in at least one material respect, however, there are circumstances (rare, but statistically significant) under which the processors will output different results even when running the same programs on the same input data. As an example, pilot inputs, such as movement of the collective, the cyclic, etc., must be measured with a high degree of accuracy in order to ensure that the FBW system is highly responsive to pilot input. Similarly, flight characteristics such as attitude and changes in attitude of the three axes, the position of the various actuators 404, and the like must also be measured with a high degree of accuracy. Hence, input data from the sensors (whether received directly from the sensors or received via intervening logic that reformats or otherwise modifies the sensor data) is input to FCCs 205 and hence to processors 412, 414 with a high degree of accuracy. All or most of the computations that processors 412, 414 perform on the data is likewise performed to a high degree of accuracy, and these computations may be performed simultaneously and in real-time on numerous different input values. While at a gross level one would expect all commercial processors to provide the same results when operating on the same input data, at the levels of accuracy required by FCCs 205, instances arise where differences between the processors 412, 414 can cause differences in the calculation results at the Nth degree of accuracy. When this occurs, processors 412 and 414 might output different results, which is referred to herein sometimes as a processor mismatch. Processor mismatches can also occur due to other causes such as, for example, chip or memory failure.

One way to approach a processor mismatch would be to consider it an error condition that necessitates a switch-over to a different processing lane or a different FCC or, alternatively, a loss of system redundancy by eliminating an FCC, for example. For example, according this approach, the outputs of command processor 412 and monitor processor 414 would both be considered, meaning that under circumstances such as those described in the preceding paragraph, one processor might direct one action be taken while the other processor directs a different action be taken. In this event, FCCs 205 would declare primary processing lane 408 unreliable and switch processing authority over to secondary processing lane 410. Alternatively, if there is no backup option, primary processing lane 408 may simply fail. While the ability to switch over to a redundant path is a keystone for reliability and for common cause mitigation, switching over unnecessarily (e.g. under conditions that do not truly reflect an error in the primary path) reduces the system's overall redundancy capability.

Advantageously, various embodiments described herein recognize that mismatches of the type described above are often a result of software complexity rather than processor or FCC-specific issues. Furthermore, with reference to FIG. 3, various embodiments described herein recognize that high software complexity is generally more prevalent in, and more typical of, outer loop 313 than rate loop 315 or inner loop 317. In the case of mismatches caused by software complexity, failing over to a different processing lane or FCC may not be the best option.

In various embodiments, system robustness can be improved via inclusion of a multi-stage remediation regime. The multi-stage remediation regime can establish multiple levels of remediation, with each level being associated with different error criteria and different remediation logic. Each set of error criteria can include error thresholds, error-frequency thresholds, and/or the like. Error thresholds may be specified in terms of any suitable metric in correspondence to the values being compared. For example, in some cases, error thresholds may be specified in terms of inches of actuator. Error-frequency thresholds can be expressed in terms of how many mismatches have occurred within a given period.

In an example, a multi-stage remediation regime can include two levels of remediation. First error criteria can include a representation of a first error threshold or value range (e.g., less than 0.19 inches of actuator) and a first error frequency (e.g., a specified number of mismatches in a given period), such that satisfaction of both the first error threshold or value range and the first error frequency results in first remediation logic being executed. Second error criteria can include a representation of a second error threshold or value range (e.g., greater than or equal to 0.19 inches of actuator) and a second error frequency (e.g., five or more mismatches in the last hour of flight), such that satisfaction of one or both of the second error threshold or value range and the second error frequency results in second remediation logic being executed.

Continuing the above example, in general, the first error criteria represents a situation in which complete failover to a different processing lane or a different FCC is deemed too severe of a remedy relative to the severity of the error. Therefore, if resultant data from a comparison between two outputs satisfies the first error criteria and errors are not sufficiently numerous or recurrent as measured by the first error frequency, a less severe remedy may be executed. The first remediation logic may include, for example, disengagement of the outer loop 313, disengagement of a sub-loop layered within the outer loop 313, disengagement of specific operations within the outer loop 313, or the like. In various embodiments, the disengagement can utilize the switch 322 of FIG. 3. Conversely, the second error criteria can represent a situation in which failover to a different processing lane or a different FCC, or loss of redundancy via elimination of an FCC, is deemed appropriate. Therefore, the second remediation logic may include, for example, failing over to a different processing lane or a different FCC or elimination of an FCC as described previously.

For purposes of illustration, two levels of error remediation are described above. However, it should be appreciated that various implementations may employ any suitable number of levels. For example, two or more progressively increasing error thresholds or value ranges can be used to specify progressively severe remediation as measured by a number of loops or operations that are disengaged. Additionally, in the above example, the first and second error criteria are mutually exclusive for illustrative purposes, although this need not be the case. For example, in some embodiments, two or more levels of remediation can provide for remediation logic that disengages different sets of loops or operations. In such embodiments, error criteria can be satisfied for one or multiple levels of remediation, with multiple sets of remediation logic being executed if multiple sets of error criteria are satisfied.

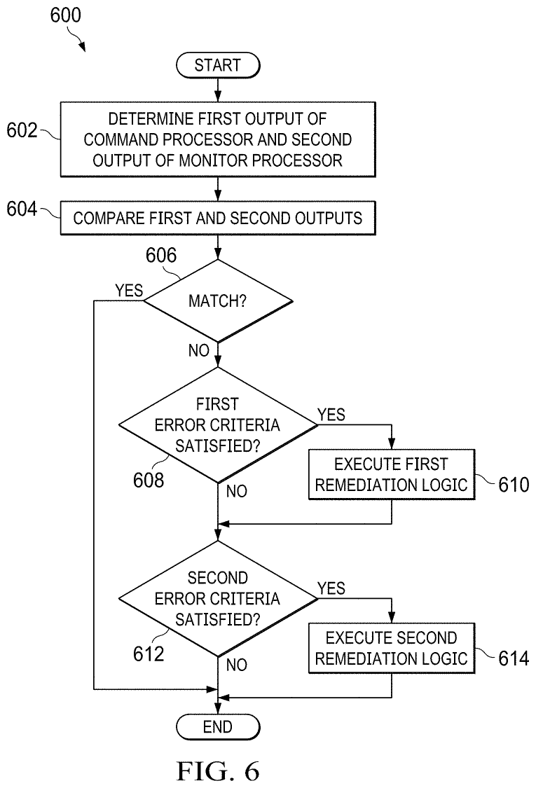

FIG. 6 illustrates an example of a process 600 for performing multiple levels of remediation in a flight control system. In various embodiments, with reference to FIG. 4, the process 600 can be executed by any of the FCCs 205, the command processor 412, the monitor processor 414, and/or another component. In some cases, the process 600 can be performed generally by the flight control system 201 of FIG. 1. Although any number components or systems can execute the process 600, for simplicity of description, the process 600 will be described relative to the FCC 205-1 of FIG. 4. In various embodiments, the process 600 can be executed each time the command processor 412 and the monitor processor 414 produce outputs.

At block 602, the FCC 205-1 determines a first output from the command processor 412 and a second output from the monitor processor 414. In various embodiments, the outputs can correspond to computations, control law states, or the like. At block 604, the FCC 205-1 compares the first output to the second output, with the comparison yielding resultant data such as, for example, whether the outputs match, a difference between outputs if the outputs do not match (e.g., inches of actuator), a number of errors within a particular time duration.

At decision block 606, the FCC 205-1 determines, based on the resultant data from the block 604, whether the first output and the second output match. If it is determined at the decision block 606 that the first output and the second output match, the process 600 ends without any remediation being performed. Otherwise, if it is determined at the decision block 606 that the first output and the second output do not match, the process 600 proceeds to decision block 608.

At decision block 608, the FCC 205-1 determines whether the resultant data from the block 604 satisfies first error criteria. The first error criteria can specify, for example, a first error threshold or value range and a first error frequency as described previously. If it is determined at the decision block 608 that the resultant data does not satisfy the first error criteria, the process 600 proceeds directly to decision block 612. Otherwise, if it is determined at the decision block 608 that the resultant data satisfies the first error criteria, the process 600 proceeds to block 610. At block 610, the FCC 205-1 executes first remediation logic as described previously. From block 610, the process 600 proceeds to decision block 612.

At decision block 612, the FCC 205-1 determines whether the resultant data from the block 604 satisfies second error criteria. The second error criteria can specify, for example, a second error threshold or value range and a second error frequency as described previously. If it is determined at the decision block 612 that the resultant data does not satisfy the second error criteria, the process 600 ends. Otherwise, if it is determined at the decision block 612 that the resultant data satisfies the second error criteria, the process 600 proceeds to block 614. At block 614, the FCC 205-1 executes second remediation logic as described previously. After block 614, the process 600 ends.

Although this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. An aircraft comprising:
a pilot input device;
a position sensor coupled to the pilot input device;
a flight condition sensor; and
a flight control computer comprising:
a first microprocessor configured to receive input data from the position sensor and the flight condition sensor and determine therefrom a first output; and
a second microprocessor configured to receive input data from the position sensor and the flight condition sensor and determine therefrom a second output;
wherein the flight control computer is configured to:
compare the first output from the first microprocessor and the second output from the second microprocessor, the comparison yielding resultant data; and
responsive to a determination that the first output and the second output do not match:
execute first remediation logic if the resultant data satisfies first error criteria; and
execute second remediation logic if the resultant data satisfies second error criteria.

2. The aircraft of claim 1, wherein the first error criteria and the second error criteria are mutually exclusive.

3. The aircraft of claim 1, wherein the second error criteria is indicative of greater error severity than the first error criteria.

4. The aircraft of claim 3, wherein the execution of the first remediation logic comprises disengagement of a first set of control operations while a second set of control operations remains engaged.

5. The aircraft of claim 3, wherein the execution of the first remediation logic comprises disengagement of a first control loop while a second control loop remains engaged.

6. The aircraft of claim 3, wherein the execution of the first remediation logic comprises disengagement of an outer control loop that focuses on at least one of guidance and tracking tasks.

7. The aircraft of claim 3, wherein the execution of the second remediation logic comprises a switch-over of processing authority to a secondary processing lane in the flight control computer.

8. The aircraft of claim 3, wherein the execution of the second remediation logic comprises a switch-over of processing authority to a different flight control computer.

9. The aircraft of claim 3, wherein the execution of the second remediation logic comprises a loss of redundancy.

10. The aircraft of claim 1, wherein the first error criteria and the second error criteria each comprise an error frequency.

11. A method comprising, by a flight control computer:
comparing a first output from a first microprocessor and a second output from a second microprocessor, the comparing yielding resultant data; and
responsive to a determination that the first output and the second output do not match:
executing first remediation logic if the resultant data satisfies first error criteria; and
executing second remediation logic if the resultant data satisfies second error criteria.

12. The method of claim 11, wherein the first error criteria and the second error criteria are mutually exclusive.

13. The method of claim 11, wherein the second error criteria is indicative of greater error severity than the first error criteria.

14. The method of claim 13, wherein the executing the first remediation logic comprises disengaging a first set of control operations while a second set of control operations remains engaged.

15. The method of claim 13, wherein the executing the first remediation logic comprises disengaging a first control loop while a second control loop remains engaged.

16. The method of claim 13, wherein the executing the first remediation logic comprises disengaging an outer control loop that focuses on at least one of guidance and tracking tasks.

17. The method of claim 13, wherein the executing the second remediation logic comprises a switch-over of processing authority to a secondary processing lane in the flight control computer.

18. The method of claim 13, wherein the executing the second remediation logic comprises a switch-over of processing authority to a different flight control computer.

19. The method of claim 11, wherein the first error criteria and the second error criteria each comprise an error frequency.

20. A flight control computer for an aircraft, the flight control computer comprising:
a first microprocessor configured to receive input data comprising a position and a flight condition and determine therefrom a first output; and
a second microprocessor configured to receive input data comprising a position and a flight condition and determine therefrom a second output; and
wherein the flight control computer is configured to:
compare the first output from the first microprocessor and the second output from the second microprocessor, the comparison yielding resultant data; and
responsive to a determination that the first output and the second output do not match:
execute first remediation logic if the resultant data satisfies first error criteria; and
execute second remediation logic if the resultant data satisfies second error criteria.
